(19) United States
(12) Patent Application Publication
(10) Pub. No.: US 2014/0062167 A1
(43) Pub. Date: Mar. 6, 2014

(54) WHEEL RIM STRUCTURE

(71) Applicant: Mu-Rong Li, Taichung City (TW)

(72) Inventor: Mu-Rong Li, Taichung City (TW)

(21) Appl. No.: 13/600,152

(22) Filed: Aug. 30, 2012

(51) Int. Cl. B60B 1/04

(52) U.S. Cl. 301/58

(57) ABSTRACT

A wheel rim structure includes a rim body having a plurality of rim connectors, each rim connectors assembled onto an inner periphery of the rim body and having a first connecting end and a second connecting end at two ends thereof, the first connecting end assembled into the inner periphery of the rim body, the second connecting end exposed from the inner periphery of the rim body, a plurality of spokes, each spoke having an assembling end and an engaging end at two ends thereof, the assembling end assembled to a wheel hub, the engaging end engaging with the second connecting end. Under this arrangement, when the user wants to detach the spokes from the rim body, the user just detaches the engaging end and the assembling end.

### BACKGROUND OF THE INVENTION

1. Field of the Invention

The present invention relates to a wheel rim and more particularly to a wheel rim structure, in which a spoke could be easily detached from a rim body or be easily assembled to the rim body.

2. Description of Related Art

Bicycle activity is more and more popular in the 21st century because bicycle activity is eco-friendly, convenient and entertaining. Many enterprises encourage their employees to go to work by bicycles instead of driving vehicles today. Many people also go shopping or go traveling by bicycles during their leisure time. After the long-term riding, the wheel rims of the bicycle are often easy to get broken. Therefore, how to provide a wheel rim structure for quickly repairing becomes an important topic when a wheel rim manufacturer designs and produces wheel rims.

A conventional wheel rim structure comprises a rim body, a plurality of assembling slots equidistantly formed along an inner circular frame of the rim body; a hub, one end of the hub being a first hub flange and another end being a second hub flange, a plurality of assembling grooves equidistantly formed around the first hub flange and the second hub flange; a plurality of spokes, one end of the spoke assembled into the assembling slot and another end of the spoke assembled into the assembling groove; and a plurality of adhesives. Under this arrangement, the adhesive is poured into the assembling slot with a constant depth and poured into the assembling groove with another constant depth, such that the spokes in the assembling slots and assembling grooves are enclosed by the adhesive. Therefore, the spoke is tightly connected in the assembling slot and assembling groove after the adhesive is solidified; the weight of the bicycle rim body is reduced because there are no bolts and nuts or other assemblies in the bicycle rim structure.

However, the conventional wheel rim structure has two disadvantages as following:

First, after the adhesives are exposed to the rain, the adhesives would be eroded by the rain, and the spokes which are enclosed by the adhesives would be unexpectedly detached from the rim body. Therefore, it is very dangerous for a rider during riding.

Second, when the rider wants to detach the spoke from the conventional wheel rim structure, the rider must break the corresponding adhesives which respectively enclose two ends of the spoke in the assembling slot and the assembling groove at first, and pull out the spoke from the assembling slot and the assembling groove forcefully. Therefore, it is very inconvenient for the rider to detach the spoke from the conventional wheel rim structure.

The present invention has arisen to mitigate and/or obviate the disadvantages of the conventional.

### SUMMARY OF THE INVENTION

The main objective of the present invention is to provide an improved wheel rim structure.

To achieve the objective, a wheel rim structure comprises a rim body having a plurality of rim connectors, the rim connectors assembled onto an inner periphery of the rim body, each rim connector having a first connecting end and a second connecting end respectively defined at two ends thereof, the first connecting end assembled into the inner periphery of the rim body, the second connecting end exposed from the inner periphery of the rim body, a plurality of spokes, each spoke having an assembling end and an engaging end respectively defined at two ends thereof, the assembling end assembled to a wheel hub, the engaging end engaging with the second connecting end of each rim connector. Wherein, the engaging end is defined at one side of each spoke; referring to each two neighbor engaging ends of each two neighbor spokes, when each two neighbor engaging ends engages with each corresponding two neighbor second connecting ends of the rim body, one engaging end faces one outer side relative to the rim body and another engaging end faces another outer side relative to the rim body; the spokes are further defined as a plurality of right spokes and a plurality of left spokes; the engaging ends are respectively defined at one side of each right spoke and each left spoke; several left spokes are arranged between each two neighbor right spokes; when the right spokes and the left spokes respectively engage with the second connecting ends of the rim body, the engaging end of each right spoke faces one outer side relative to the rim body, and the engaging end of each left spoke faces another outer side relative to the rim body; the wheel rim structure of the present invention further comprises a plurality of hub connectors; each hub connector has a first threaded end and a second threaded end at two ends thereof; the wheel hub has a plurality of first threaded holes opened along two end peripheries of the wheel hub; each first threaded end is screwed into each corresponding first threaded hole; the assembling end of each spoke has a second threaded hole; each second threaded end is screwed into each corresponding second threaded hole; the rim connector has a connecting portion connected between the first connecting end and the second connecting end; a transverse width of the connecting portion is smaller than another transverse width of the first connecting end or the other transverse width of the second connecting end; an inner surface of the second connecting end is concaved from two ends thereof toward the connecting portion; an outer surface of the second connecting end is convex from two ends thereof toward a center thereof; the engaging end has an engaging groove and a communicating groove; the engaging groove is close to the wheel hub and the communicating groove is close to the rim body; the communicating groove communicates with the engaging groove and an outside relative to the engaging end at two ends thereof; a transverse width of the engaging groove is larger than another transverse width of the communicating groove; the second connecting end of the rim connector is engaged with the engaging groove of the spoke; the connecting portion of the rim connector is received into the communicating groove of the spoke; when the spoke is assembled to the rim connector of the rim body, a distance would be defined between the spoke the rim body; the first connecting end has a plurality of reinforcing grooves.

Under this arrangement, when the user wants to detach the spokes from the rim body, the user disengages the engaging end of each spoke from the second connecting end of each rim connector firstly; and then, the user detaches the assembling end of each spoke from the wheel hub; as a result, each spoke is detached from the rim body.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wheel rim structure of the present invention which is performed as a front wheel;

FIG. 2 is an exploded view for showing a spoke and a rim connector;

FIG. 3 is a cross-sectional view for showing the rim connector which is assembled between a rim body and the spoke;

FIG. 4 is an enlarged view for showing the rim connector;

FIG. 5 is an exploded view for showing a hub connector which is used to be connected between a wheel hub and the spoke;

FIG. 6 is a perspective view of a wheel rim structure of the present invention which is performed as a rear wheel;

FIG. 7 is a perspective view for showing the hub connector which is being rotated; and

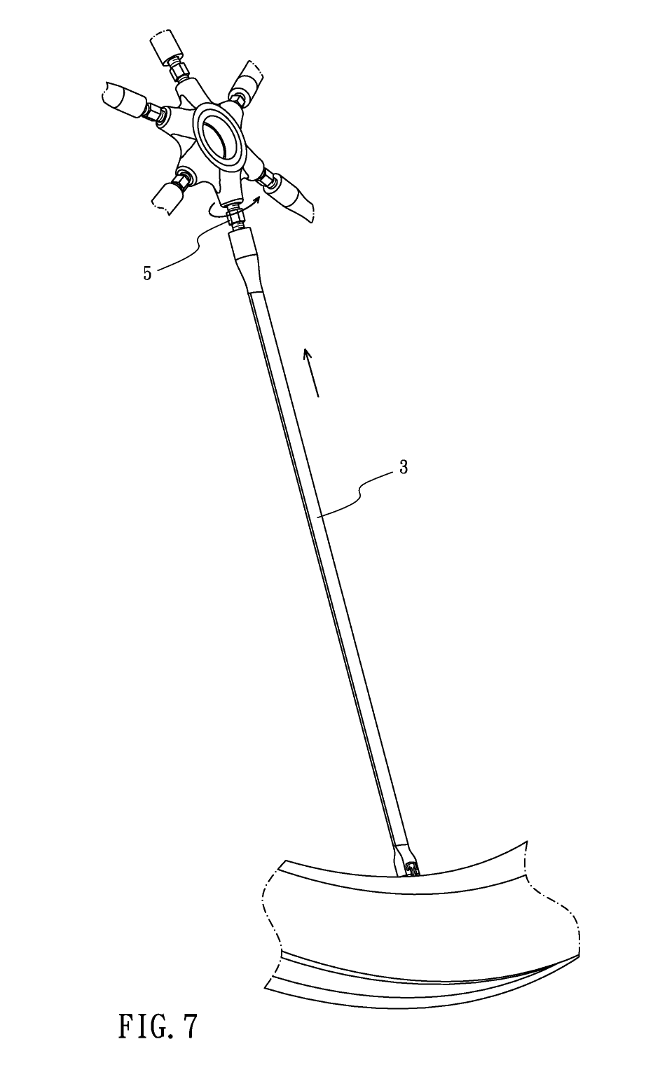

FIG. 8 is an enlarged side view for showing the rim connector which is assembled between the rim body and the spoke.

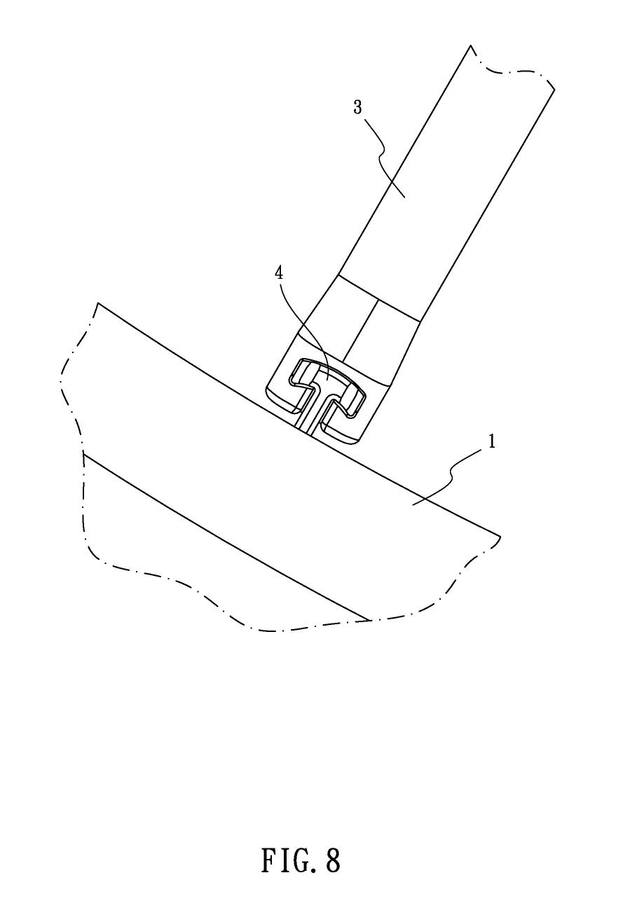

### DETAILED DESCRIPTION OF THE INVENTION

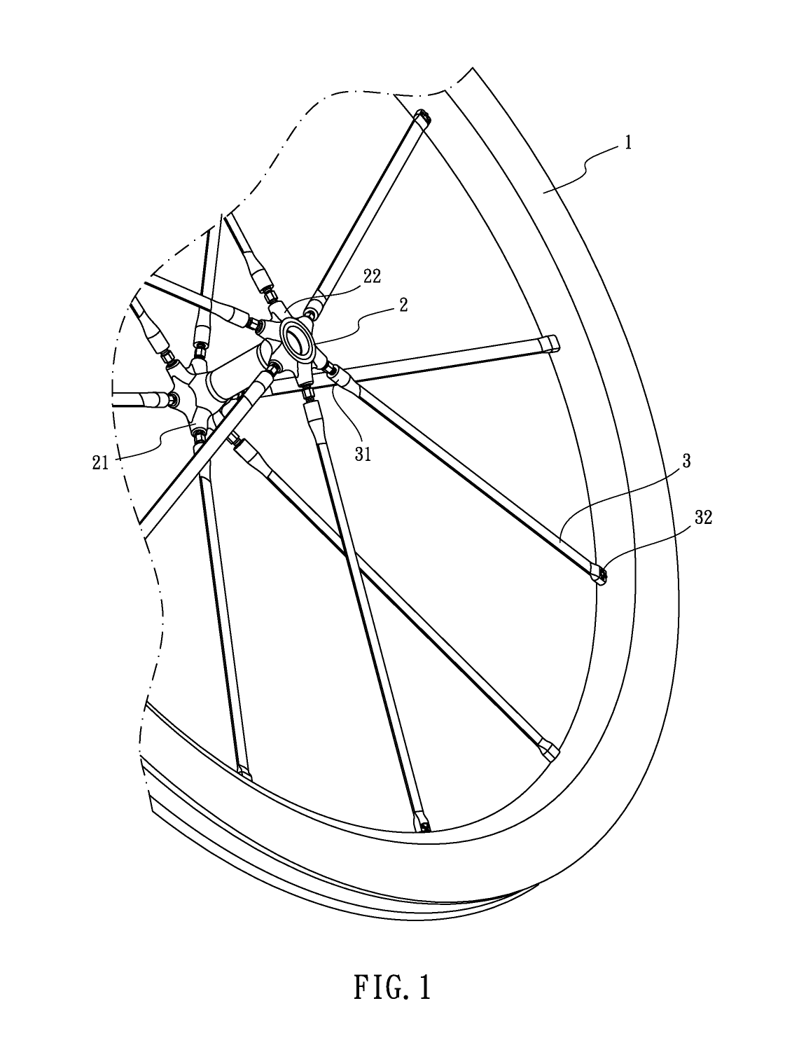

Referring to FIGS. 1-4, a wheel rim structure in accordance with the present invention comprises a rim body 1, a wheel hub 2 and a plurality of spokes 3. A plurality of rim connectors 4 is assembled onto an inner periphery of the rim body 1. Each rim connector 4 has a first connecting end 41 and a second connecting end 42 respectively defined at two ends thereof. The first connecting end 41 is assembled into the inner periphery of the rim body 1. The second connecting end 42 is exposed from the inner periphery of the rim body 1. Each spoke 3 has an assembling end 31 and an engaging end 32 respectively defined at two ends thereof. The assembling end 31 is assembled to the wheel hub 2. The engaging end 32 engages with the second connecting end 42 of each rim connector 4.

Under this arrangement, when a user wants to assemble the spokes 3 to the rim body 1, the user assembles the assembling end 31 of each spoke 3 to the wheel hub 2 firstly; and then, the user engages the engaging end 32 of each spoke 3 with the second connecting end 42 of each rim connector 4; as a result, each spoke 3 is assembled to the rim body 1. In contrast, when the user wants to detach the spokes 3 from the rim body 1, the user disengages the engaging end 32 of each spoke 3 from the second connecting end 42 of each rim connector 4 at first; and then, the user detaches the assembling end 31 of each spoke 3 from the wheel hub 2; as a result, each spoke 3 is detached from the rim body 1. Therefore, it is very convenient for the user to detach the spoke 3 from the wheel rim structure of the present invention as the above description; in addition, it is unnecessary to use a plurality of adhesives (not shown) as the prior art, for reinforcing a connection between each spoke 3 and the wheel rim structure.

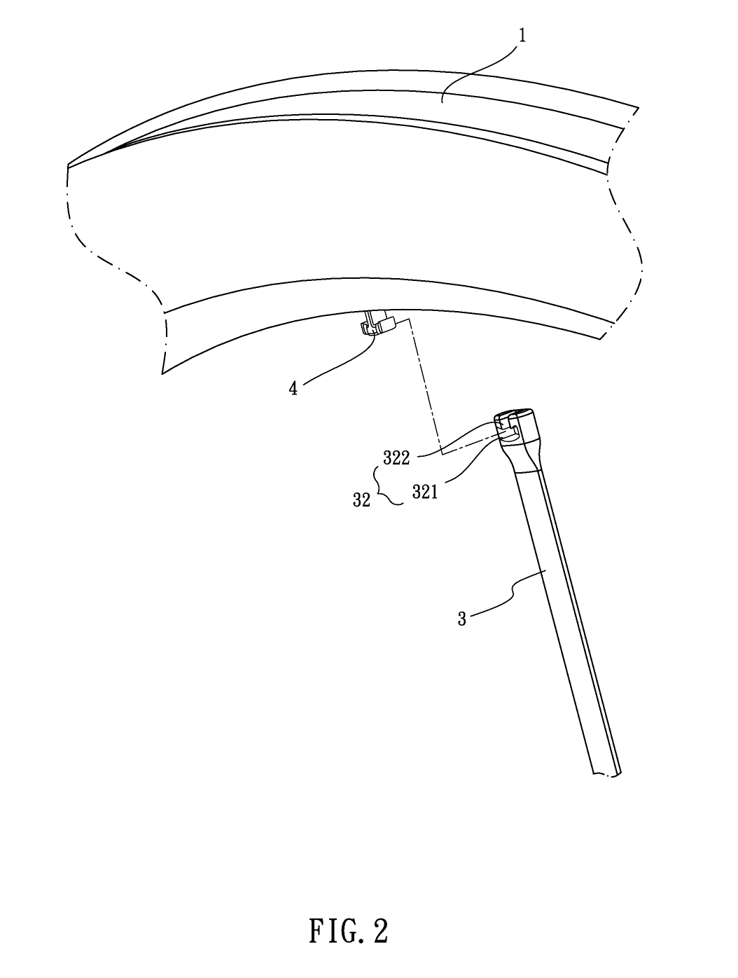

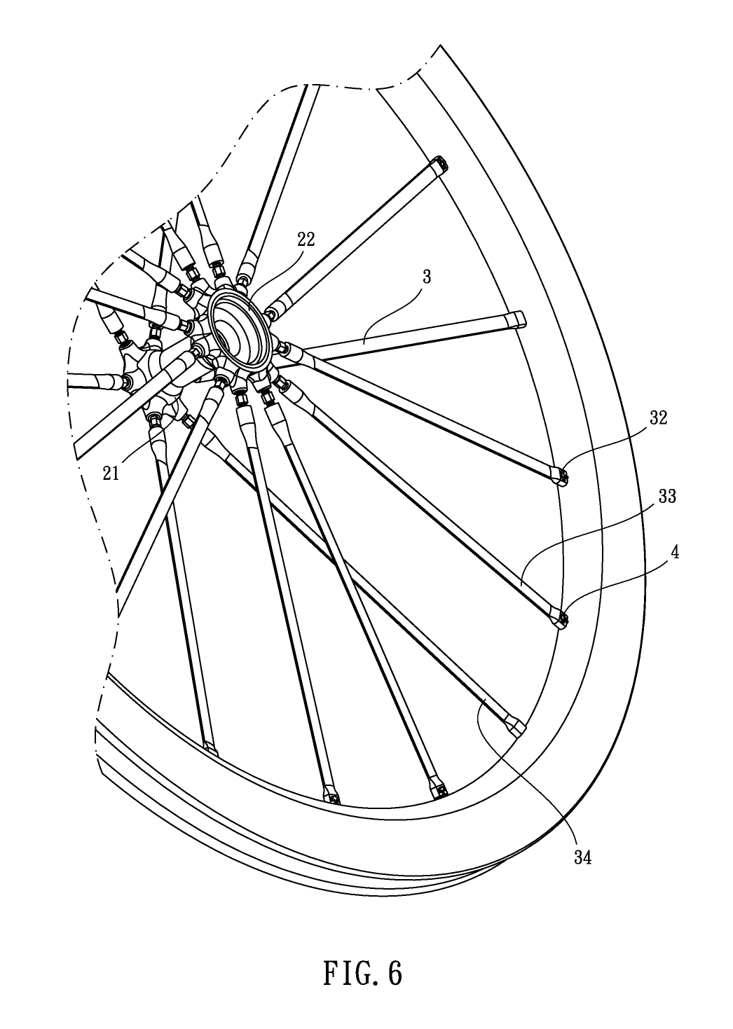

Furthermore, the present invention can be performed as a front wheel (as shown in FIG. 1) or a rear wheel (as shown in FIG. 6). The wheel hub 2 has a first hub flange 21 and a second hub flange 22 defined at two ends thereof. Referring to FIGS. 1-2, the engaging end 32 is defined at one side of each spoke 3. Referring to each two neighbor engaging ends 32 of each two neighbor spokes 3, when each two neighbor engaging ends 32 engages with each corresponding two neighbor second connecting ends 42 of the rim body 1, one engaging end 32 faces one outer side relative to the rim body 1 and another engaging end 32 faces another outer side relative to the rim body 1. In the preferred embodiment of the present invention, the first hub flange 21 has six spokes 3 assembled thereon and the second hub flange 22 also has six spokes 3 assembled thereon. The spokes 3 of the first hub flange 21 are not aligned with the spokes 3 of the second hub flange 22, so that the spokes 3 of the first hub flange 21 and the spokes 3 of the second hub flange 22 are alternately arranged on the rim body 1. When each engaging end 32 engages with each corresponding second connecting end 42 of the rim body 1, the spokes 3 of the first hub flange 21 all face one further outer side relative to the first hub flange 21, and the spokes 3 of the second hub flange 22 all face another further outer side relative to the second hub flange 22.

Referring to FIG. 6, the present invention is performed as a rear wheel. The spokes 3 are further defined as a plurality of right spokes 33 and a plurality of left spokes 34. The right spokes 33 are assembled to the second hub flange 22, and the left spokes 34 are assembled to the first hub flange 21. The engaging ends 32 are respectively defined at one side of each right spoke 33 and each left spoke 34. Several left spokes 34 are arranged between each two neighbor right spokes 33 (in the present invention, two left spokes 34 are arranged between each two neighbor right spokes 33). When the right spokes 33 and the left spokes 34 respectively engage with the second connecting ends 42 of the rim body 1, the engaging end 32 of each right spoke 33 faces one outer side relative to the rim body 1, and the engaging end 32 of each left spoke 34 faces another outer side relative to the rim body 1. In the preferred embodiment of the present invention, the first hub flange 21 has twelve left spokes 34 assembled thereon and the second hub flange 22 has six right spokes 33 assembled thereon. When the right spokes 33 and the left spokes 34 respectively engage with the second connecting ends 42 of the rim body 1, the left spokes 34 of the first hub flange 21 all face one further outer side relative to the first hub flange 21, and the right spokes 33 of the second hub flange 22 all face another further outer side relative to the second hub flange 22. Therefore, there are two left spokes 34 which are arranged between each two neighbor right spokes 33.

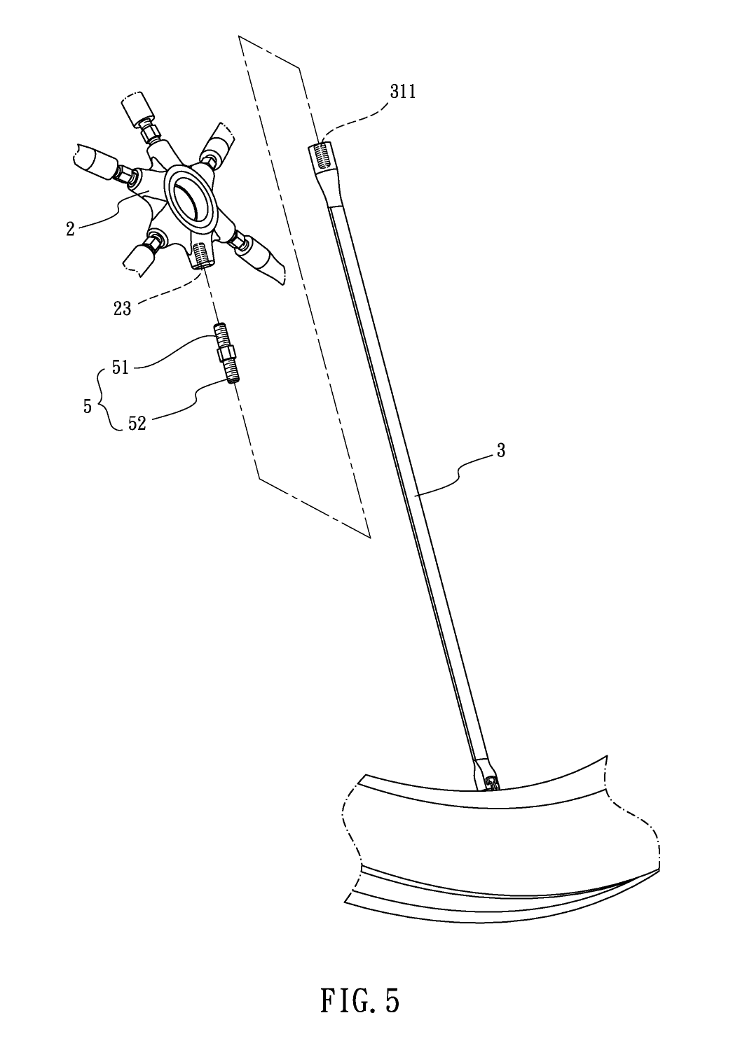

Referring to FIGS. 5-6, the wheel rim structure of the present invention further comprises a plurality of hub connectors 5. Each hub connector 5 has a first threaded end 51 and a second threaded end 52 at two ends thereof. The wheel hub 2 has a plurality of first threaded holes 23 opened along two end peripheries of the wheel hub 2. Each first threaded end 51 is screwed into each corresponding first threaded hole 23. The assembling end 31 of each spoke 3 has a second threaded hole 311. Each second threaded end 52 is screwed into each corresponding second threaded hole 311. Under this arrangement, the user can rotate one hub connector 5 for adjusting a tension of one corresponding spoke 3.

The features of the present invention are further described as following:

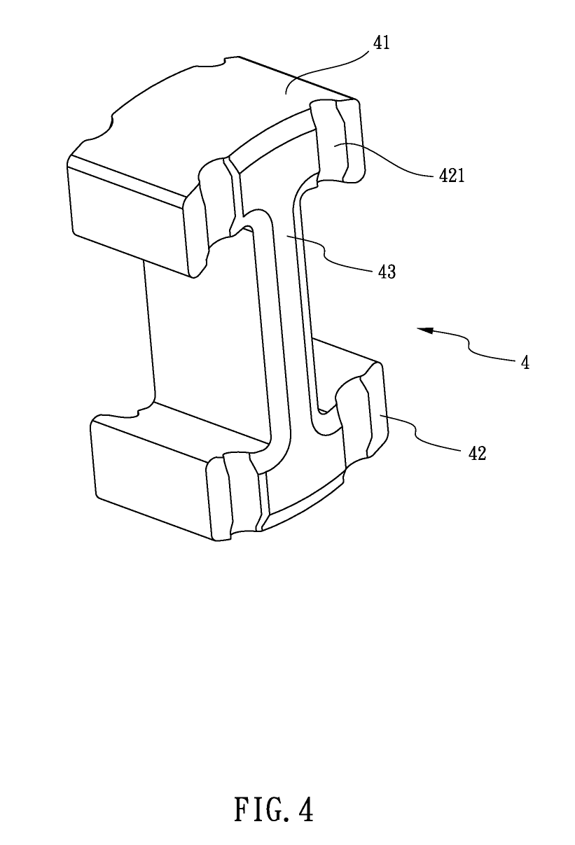

1. Referring to FIG. 4, the rim connector 4 has a connecting portion 43 connected between the first connecting end 41 and the second connecting end 42. A transverse width of the connecting portion 43 is smaller than another transverse width of the first connecting end 41 or the other transverse width of the second connecting end 42. Therefore, when the first connecting end 41 of the rim connector 4 is assembled into the rim body 1, the rim connector 4 would not be unexpectedly detached from the rim body 1.

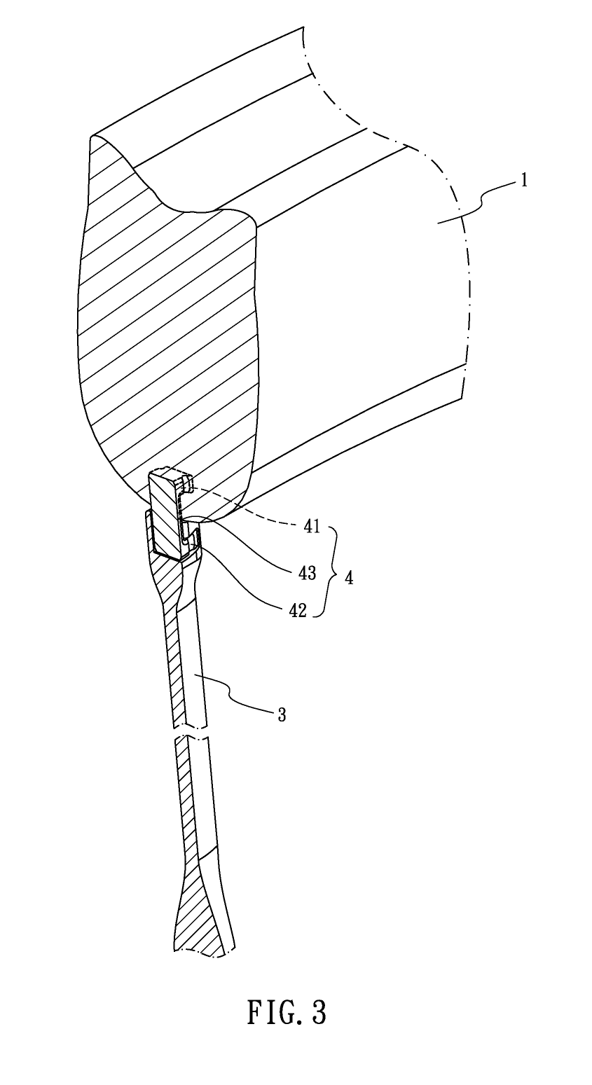

2. An inner surface of the second connecting end 42 is concaved from two ends thereof toward the connecting portion 43. An outer surface of the second connecting end 42 is convex from two ends thereof toward a center thereof, so that the second connecting end 42 is formed as a hook (as shown in FIG. 3). Therefore, when the rim body 1 is rotated during riding, the second connecting end 42 of the rim connector 4 is tightly engaged with the engaging end 32 of the spoke 3, so as to prevent the spoke 3 unexpectedly being detached from the rim connector 4 of the rim body 1.

3. Referring to FIG. 2, the engaging end 32 has an engaging groove 321 and a communicating groove 322. The engaging groove 321 is close to the wheel hub 2 and the communicating groove 322 is close to the rim body 1. The communicating groove 322 communicates with the engaging groove 321 and an outside relative to the engaging end 32 at two ends thereof. A transverse width of the engaging groove 321 is larger than another transverse width of the communicating groove 322 (as shown in FIG. 2). The second connecting end 42 of the rim connector 4 is engaged with the engaging groove 321 of the spoke 3. The connecting portion 43 of the rim connector 4 is received into the communicating groove 322 of the spoke 3. Therefore, when the rim connector 4 is assembled to the spoke 3 via the second connecting end 42 and the engaging groove 321, the rim connector 4 would not be unexpectedly detached from the spoke 3.

4. When the spoke 3 is assembled to the rim connector 4 of the rim body 1, a distance would be defined between the spoke 3 the rim body 1. Therefore, the tension of one corresponding spoke 3 could be adjusted because of the above distance.

5. The first connecting end 41 has a plurality of reinforcing grooves 421. Each reinforcing groove 421 engages with an inner wall of the rim body 1, when the rim connector 4 is assembled to the rim body 1. Therefore, a connection between the rim body 1 and the rim connector 4 is reinforced.

Although the invention has been explained in relation to its preferred embodiment, it is to be understood that many other possible modifications and variations can be made without departing from the spirit and scope of the invention as hereinafter claimed.

What is claimed is:

1. A wheel rim structure comprising:
a rim body having a plurality of rim connectors, the rim connectors assembled onto an inner periphery of the rim body, each rim connector having a first connecting end and a second connecting end respectively defined at two ends thereof, the first connecting end assembled into the inner periphery of the rim body, the second connecting end exposed from the inner periphery of the rim body; and
a plurality of spokes, each spoke having an assembling end and an engaging end respectively defined at two ends thereof, the assembling end assembled to a wheel hub, the engaging end engaging with the second connecting end of each rim connector;
wherein, when the user wants to detach the spokes from the rim body, the user disengages the engaging end of each spoke from the second connecting end of each rim connector firstly; and then, the user detaches the assembling end of each spoke from the wheel hub; as a result, each spoke is detached from the rim body.

2. The wheel rim structure as claimed in claim 1, wherein the engaging end is defined at one side of each spoke; referring to each two neighbor engaging ends of each two neighbor spokes, when each two neighbor engaging ends engages with each corresponding two neighbor second connecting ends of the rim body, one engaging end faces one outer side relative to the rim body and another engaging end faces another outer side relative to the rim body.

3. The wheel rim structure as claimed in claim 1, wherein the spokes are further defined as a plurality of right spokes and a plurality of left spokes; the engaging ends are respectively defined at one side of each right spoke and each left spoke; several left spokes are arranged between each two neighbor right spokes; when the right spokes and the left spokes respectively engage with the second connecting ends of the rim body, the engaging end of each right spoke faces one outer side relative to the rim body, and the engaging end of each left spoke faces another outer side relative to the rim body.

4. The wheel rim structure as claimed in claim 1, wherein the wheel rim structure of the present invention further comprises a plurality of hub connectors; each hub connector has a first threaded end and a second threaded end at two ends thereof; the wheel hub has a plurality of first threaded holes opened along two end peripheries of the wheel hub; each first threaded end is screwed into each corresponding first threaded hole; the assembling end of each spoke has a second threaded hole; each second threaded end is screwed into each corresponding second threaded hole.

5. The wheel rim structure as claimed in claim 1, wherein the rim connector has a connecting portion connected between the first connecting end and the second connecting end; a transverse width of the connecting portion is smaller than another transverse width of the first connecting end or the other transverse width of the second connecting end.

6. The wheel rim structure as claimed in claim 5, wherein an inner surface of the second connecting end is concaved from two ends thereof toward the connecting portion; an outer surface of the second connecting end is convex from two ends thereof toward a center thereof.

7. The wheel rim structure as claimed in claim 5, wherein the engaging end has an engaging groove and a communicating groove; the engaging groove is close to the wheel hub and the communicating groove is close to the rim body; the communicating groove communicates with the engaging groove and an outside relative to the engaging end at two ends thereof; a transverse width of the engaging groove is larger than another transverse width of the communicating groove; the second connecting end of the rim connector is engaged with the engaging groove of the spoke; the connecting portion of the rim connector is received into the communicating groove of the spoke.

8. The wheel rim structure as claimed in claim 1, wherein when the spoke is assembled to the rim connector of the rim body, a distance would be defined between the spoke the rim body.

9. The wheel rim structure as claimed in claim 1, wherein the first connecting end has a plurality of reinforcing grooves.
